(19) United States
(12) Patent Application Publication
(10) Pub. No.: US 2017/0054969 A1
(43) Pub. Date: Feb. 23, 2017

(54) Light path Layout Structure of High-definition Naked-Eye Portable Stereoscopic Video Display and Light path Thereof

(71) Applicant: HANGZHOU 3DWORLD TECHNOLOGY CO., LTD., Hangzhou (CN)

(72) Inventor: Xiaofen LU, Hangzhou (CN)

(73) Assignee: HANGZHOU 3DWORLD TECHNOLOGY CO., LTD., Hangzhou (CN)

(21) Appl. No.: 15/305,662

(22) PCT Filed: Oct. 10, 2014
(86) PCT No.: PCT/CN2014/088264

§ 371 Date: Oct. 21, 2016

(30) Foreign Application Priority Data
Jun. 7, 2014 (CN) 201410248989.8
Jun. 7, 2014 (CN) 201420299426.7
Jun. 7, 2014 (CN) 2014202994252

(51) Int. Cl. H04N 13/04; G02B 27/22

(52) U.S. Cl. CPC H04N 13/0402; G02B 27/2242; G02B 27/2235

(57) ABSTRACT

The present invention relates to a light path layout structure of a high-definition naked-eye portable stereoscopic video display and a light path circuit which enables the user to watch a stereoscopic video without wearing the stereoscopic glasses. Two video signals that are output from the stereoscopic video playing circuit board are synchronously displayed on a left liquid crystal display screen and a right liquid crystal display screen respectively. Sights from the left eye and the right eye of a person pass through a left eyepiece and a right eyepiece to a left eye reflector and a right eye reflector respectively. Images played on the left liquid crystal display screen and the right liquid crystal display screen are viewed via the left eye reflector and the right eye reflector respectively.

### CROSS REFERENCE TO RELATED APPLICATIONS

This application is a continuation of International Application No. PCT/CN2014/088264, filed on Oct. 10, 2014, which is based upon and claims priority to Chinese Patent Application No. 201410248989.8 filed on Jun. 7, 2014, Chinese Patent Application No. 201420299426.7 filed on Jun. 7, 2014, and Chinese Patent Application No. 2014202994252 filed on Jun. 7, 2014, the entire contents of which are incorporated herein by reference.

### TECHNICAL FIELD

The present invention relates to a light path layout structure of a high-definition naked-eye portable stereoscopic video display and a light path circuit which enables the user to watch a stereoscopic video without wearing the stereoscopic glasses. The present invention belongs to the field of manufacturing a microscopic stereoscopic video player/viewer.

### BACKGROUND ART

1. A patent titled “stereoscopic display viewable by naked eyes” (CN101594549A) includes a black baffle (2), a right convex lens (3), a left convex lens (4) and an LCD video player (7). The display is a box, a top panel of which is parallel to a bottom panel. The black baffle (2) forms three sides of the box. The right convex lens (3) and the left convex lens (4) are installed in a convex lens installing round hole of the top panel through an optical axis thereof in a parallel way respectively. The distance between the optical axis of the right convex lens (3) and the optical axis of the left convex lens (4) is 6-7 cm. The LCD video player (7) includes a screen (1), wherein the screen (1) is a display of the LCD video player (7), and the screen (1) includes a right screen (10) and a left screen (11). The right screen (10) and the left screen (11) are located in the left half part and the right half part of the screen (1) respectively. The right screen (10) and the left screen (11) are fixed on the upper surface of the bottom panel in such a way that the right screen (10) and the left screen (11) are located below the right convex lens (3) and the left convex lens (4) respectively. The distance between the screen (1) of the LCD video player (7) and the right convex lens (3) and the left convex lens (4) is 8-12 cm. The LCD video player (7) further includes a USB data transmission port (6). the USB data transmission port (6) is installed on the left side panel of the black baffle (2). See FIG. 2 and FIG. 3.

The disadvantages are as follows: first, the patent recites “the distance between the optical axis of the right convex lens (3) and the optical axis of the left convex lens (4) is 6-7 cm”, and “the distance between the screen (1) of the LCD video player (7) and the right convex lens (3) and the left convex lens (4) is 8-12 cm”, which indicates that the shortest focal distance of the optical convex lens is 8 cm. The screens as shown in the figure of the patent are arranged side by side. The maximum size of the single image arranged in parallel is unlikely to exceed the 6.5 cm which is the distance between eyes of a person. The normal view angle of a film should be optically designed more than 40°. The amplification factor should be more than 3 times. The diameter of the lens is about 2 cm (this also complies with that the convex lens of the patent is a small round lens as shown in the figure). As the diameter of the lens is small, the eyes of the user should be as close as possible to the lens during watching. This mode is not substantially different from the head-mounted stereoscopic display sold in the market. It does not have the basic characteristic that the eyes can freely move up and down, left and right, forward and backward in the naked-eye stereoscopic mode. Therefore, it is hard to be called the perfect naked-eye stereoscopic characteristic. Second, the width of the image is 6.5 cm. The resolution can be 1000 pixels at most according to the resolution of the mainstream product LCD screen of the current screen, which is only half of the high-definition screen. Third, the pixel of the LCD screen is viewed under a 3-time eyepiece through which large pixel grain can be seen. this cannot meet the basic viewing requirement of the non-grainy sense of the movies.

2. The previous patent CN90217663 of the inventor of the application is titled “stereoscopic display for stereogram”. The stereoscopic display is provided with a shell (1), a planar reflector (2), a stereogram pair frame (3), a longitudinal partition board (4), a diffusion plate (5), an electric light source, a wire and a power line connecting to the electric light source. The upper end of the shell (1) is fixed to a piano-convex lens screen (6). The lens screen is composed of two identical rectangular piano-convex lenses that is combined together closely in parallel. The convex surface of the lens is oriented toward the inner cavity of the shell. The range of the focal length of the lens is 200-250 mm. The length of the lens screen is 120-140 mm. The width is 80-100 mm. The inclined inner wall of the middle of the shell (1) is fixedly provided with a rectangular planar reflector (2). The included angle between the plane of the planar reflector (2) and the lens screen (6) is 45′. The middle part of the shell which is opposite to the inner wall of the planar reflector is provided with an electric direct light source (7). The lower part of the shell is provided with the movable stereogram pair frame (3). The included angle of the plane of the frame and the planar reflector is 45°. The longitudinal partition board (4) is fixed at the middle part of the inner cavity of the shell (1) from the piano-convex lens screen to the stereogram pair frame. The diffusion plate (5) which is parallel to the framework (3) is arranged below the stereogram pair frame (3). An electric transmission light source (8) is arranged below the diffusion plate (5), a change-over switch (9) of the electric direct light source and the electric transmission light source is provided on the step on the outer surface of the lower part of the shell (1) electric light source The change-over switch (9) is connected in series in the circuit of the electric light source. See FIG. 2 and FIG. 3. The patent recites that when the traditional stereoscopic viewing device uses the eyepiece with a short focal length to view the stereoscopic image, the eyes of the user must be as close as possible to the lens. The range in which the eyes can move with respect to the lens is very small. The stereoscopic image will disappear if the eyes depart from the specific position. The disadvantages of this patent are as follows: as the lens adopts the lens whose focus range of 200-250 mm, when the lens is the plano-convex lens (not the telescope), the size of focal length is 200 nm>the image width size of 65 mm. The magnification of the image cannot be more than 1 time. Therefore, the stereoscopic image formed by this patent technology must be the small-sized image, which can be served as a certain stereoscopic image for viewing, but cannot reach the visual effect of watching the large stereoscopic image in the cinema whose field angle is more than 40°.

### SUMMARY OF THE INVENTION

Design Purpose: in order to avoid the shortage of the background art, a light path layout structure of a high-definition naked-eye portable stereoscopic video display and a light path thereof which enables a user to view a stereoscopic video without wearing stereoscopic glasses is designed.

Design Solution: in order to achieve the foregoing design object. 1. The first technical feature of the present invention is the design in which a left eyepiece and a right eyepiece are directly opposite to a left eye reflector and a right eye reflector, and the left eye reflector and the right eye reflector form an included angle of 90°. The purpose of such design is as follows: as the display surface of a left liquid crystal display screen and the display surface of a right liquid crystal display screen are opposite to the mirror surface of a left eye reflector and the mirror surface of a right eye reflector respectively, and are transversely arranged, sights of a left eye and a right eye of a person pass through a left eyepiece and a right eyepiece to the left eye reflector and a right eye reflector respectively. As an included angle of the left eye reflector and the right eye, reflector is 90°, the mirror surface of the left eye reflector and the mirror surface of the right eye reflector are opposite to the left eyepiece and the right eyepiece at an angle of 45° respectively. The sight of the left eye and that of the right eye of the person are reflected by the left eye reflector and the right eye reflector to images played on the left liquid crystal display screen and the right liquid crystal display screen. Since the distance between two eyes of the person is about 65 mm, two images of the same object at different angles are seen, such that a stereoscopic vision is generated via brain synthesis. 2. The design in which the sight partition board is located between the left eyepiece and the right eyepiece is the second technical feature of the present invention. The purpose of this design is as follows: it can separate the sight of the left eye and that of the right eye of the person, avoiding the corner of the left eye sees the right light path or the corner of the right eye sees the left light path, so as to ensure that the left light path and the right light path entering the brain are not mixed. Thus, the person who is viewing the stereoscopic video does not feel dizzy.

Technical solution 1: in a light path layout structure of a high-definition naked-eye portable stereoscopic video display, a left eyepiece and a right eyepiece are directly opposite to a left eye reflector and a right eye reflector. The left eye reflector and the right eye reflector form an included angle of 90°. The display surface of a left liquid crystal display screen and the display surface of a right liquid crystal display screen are opposite to the left eye reflector and the right eye reflector respectively. A sight partition board is located between the left eyepiece and the right eyepiece. The stereoscopic video playing circuit board is opposite to the flaring of the included angle of the left liquid crystal display screen and the right liquid crystal display screen.

Technical solution 2: in a light path layout structure of a high-definition naked-eye portable stereoscopic video display, two video signals is output from the stereoscopic video playing circuit board to the left liquid crystal display screen and the right liquid crystal display screen respectively. The two video signals are synchronously displayed. Sights from the left eye and the right eye of the person pass through the left eyepiece and the right eyepiece to the left eye reflector and the right eye reflector respectively. Images played on the left liquid crystal display screen and the right liquid crystal display screen can be viewed via the left eye reflector and the right eye reflector respectively.

### Advantageous Effects

Compared with the background art, in the present invention, first, the design in which the left eye reflector and the right eye reflector form the included angle of 90° realizes an arrangement in which the display surface of a left liquid crystal display screen and the display surface of a right liquid crystal display screen form an included angle of 45° with the left eye reflector and the right eye reflector relatively, which not only reduces the volume of the display and thus is convenient to carry around, but also achieves the goal of high-definition viewing with naked eyes. Second, the left liquid crystal display screen and the right liquid crystal display screen are transversely opposite to the left eye reflector and the right eye reflector, realizing the viewing of the stereoscopic wide screen. Third, the manufacturing cost is low and the reliability is high.

### BRIEF DESCRIPTION OF THE DRAWINGS

FIG. 1 is a schematic diagram of a light path layout structure of high-definition naked-eye portable stereoscopic video display and light path circuit.

FIG. 2 and FIG. 3 are structure diagrams of the background art.

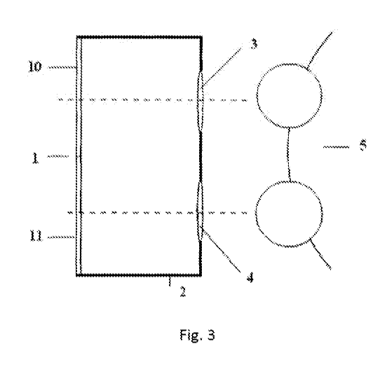

### DETAILED DESCRIPTION OF THE PREFERRED EMBODIMENTS

### Embodiment 1

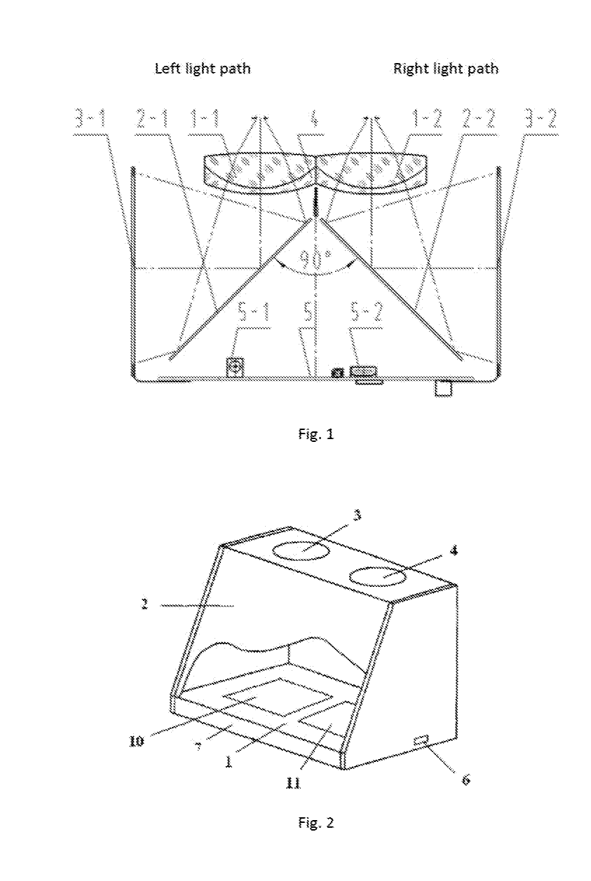

see FIG. 1. in a light path layout structure of a high-definition naked-eye portable stereoscopic video display left eyepiece 1-1 and right eyepiece 1-2 are directly opposite to left eye reflector 2-1 and right eye reflector 2-2. Left eye reflector 2-1 and right eye reflector 2-2 are at an included angle of 90°. The display surface of left liquid crystal display screen 3-1 and the display surface of right liquid crystal display screen 3-2 are opposite to left eye reflector 2-1 and right eye reflector 2-2 respectively. Sight partition board 4 is located between left eyepiece 1-1 and right eyepiece 1-2. Stereoscopic video playing circuit board 5 is opposite to the flaring of the included angle between left liquid crystal display screen 3-1 and right liquid crystal display screen 3-2. Stereoscopic video playing circuit board 5 is provided with circuit socket 5-1, stereoscopic video audio signal input interface 5-2 and a video audio output interface. Left liquid crystal display screen 3-1 and right liquid crystal display screen 3-2 are mobile phone display screens. Left liquid crystal display screen 3-1 and right liquid crystal display screen 3-2 are transversely opposite to left eye reflector 2-1 and right eye reflector 2-2 respectively. Left eyepiece 1-1 and right eyepiece 1-2 are two identical piano-convex lenses, which are made of rectangular lens with a length of 80-100 mm and a width of 60-70 mm. With such a size of rectangular lens, “the range in which the eye of the person can move with respect to the plano-convex lens screen is enlarged, and the user can comfortably sit in front of lens screen to watch the stereoscopic image without feeling tired”. Left liquid crystal display screen 3-1 and right liquid crystal display screen 3-2 are a 1080P LCD display screen or 1080P display screen. The size of left liquid crystal display screen 3-1 and that of right liquid crystal display screen 3-2 are 3-inch screen˜8-inch screen.

### Embodiment 2

on basis of Embodiment 1, in a light path layout structure of a high-definition naked-eye portable stereoscopic video display, two video signals are output from the stereoscopic video playing circuit board 5 to left liquid crystal display screen 3-1 and right liquid crystal display screen respectively. The two video signals are displayed synchronously. Sights of the left eye and the right eye of a person pass through left eyepiece 1-1 and right eyepiece 1-2 to left eye reflector 2-1 and right eye reflector 2-2 respectively. The user views images played on left liquid crystal display screen 3-1 and right liquid crystal display screen 3-2 through left eye reflector 2-1 and right eye reflector 2-2 respectively.

It should be noted that: although the above embodiments describe the concept of the present invention in detail, the literal description is only simple literal description of the concept of the present invention, without limiting the conception of the present invention. Any combination, addition or amendment that does not go beyond the concept of the present invention falls within the scope of the invention.

1. A light path layout structure of a high-definition naked-eye portable stereoscopic video display, comprising:
a left eyepiece,
a right eyepiece,
a right eye reflector, and
a left eye reflector,
wherein the right eye eyepiece is located directly opposite the right eye reflector,
wherein the left eye reflector and the right eye reflector form an included angle of 90°,
wherein a display surface of a left liquid crystal display screen and a display surface of a right liquid crystal display screen are opposite to the left eye reflector and the right eye reflector respectively,
wherein a sight partition board is located between the left eyepiece and the right eyepiece, and
wherein a stereoscopic video playing circuit board is opposite to the flaring of the included angle between the left liquid crystal display screen and the right liquid crystal display screen.

2. The light path layout structure of the high-definition naked-eye portable stereoscopic video display according to claim 1, wherein the stereoscopic video playing circuit board is provided with a circuit socket, a stereoscopic video audio signal input interface and a video audio output interface.

3. The light path layout structure of the high-definition naked-eye portable stereoscopic video display according to claim 1,
wherein the left liquid crystal display screen and the right liquid crystal display screen are mobile phone display screen, and
wherein the left liquid crystal display screen and the right liquid crystal display screen are transversely opposite to the left eye reflector and the right eye reflector respectively.

4. The light path layout structure of the high-definition naked-eye portable stereoscopic video display according to claim 3, wherein the left liquid crystal display screen and the right liquid crystal display screen are 1080PLCD display screen or 1080P display screen.

5. The light path layout structure of the high-definition naked-eye portable stereoscopic video display according to claim 3, wherein a size of the left liquid crystal display screen and that of the right liquid crystal display screen are 3-inch screen˜8-inch screen.

6. The light path layout structure of the high-definition naked-eye portable stereoscopic video display according to claim 1, wherein the left eyepiece and the right eyepiece are two identical plano-convex lens, which are made of rectangular lens with a length of 80-100 mm and a width of 60-70 mm.

7. A light path of a high-definition naked-eye portable stereoscopic video display,
wherein two video signals is output from the stereoscopic video playing circuit board to the left liquid crystal display screen and the right liquid crystal display screen respectively,
wherein the two video signals are synchronously displayed, wherein sights from the left eye and the right eye of a person pass through the left eyepiece and the right eyepiece to the left eye reflector and the right eye reflector respectively, and
wherein images played on the left liquid crystal display screen and the right liquid crystal display screen are watched through the left eye reflector and the right eye reflector respectively.

8. The light path layout structure of the high-definition naked-eye portable stereoscopic video display according to claim 3, wherein the left eyepiece and the right eyepiece are two identical piano-convex lens, which are made of rectangular lens with a length of 80-100 mm and a width of 60-70 mm.
